(19) United States
(12) Patent Application Publication
(10) Pub. No.: US 2020/0132134 A1
(43) Pub. Date: Apr. 30, 2020

(54) ONE-WAY CLUTCH

(71) Applicant: JTEKT CORPORATION, Osaka-shi, Osaka (JP)

(72) Inventor: Hiroshi OGAWA, Oume-shi (JP)

(73) Assignee: JTEKT CORPORATION, Osaka-shi, Osaka (JP)

(21) Appl. No.: 16/627,952

(22) PCT Filed: Jul. 17, 2018
(86) PCT No.: PCT/JP2018/026675

§ 371 Date: Dec. 31, 2019

(30) Foreign Application Priority Data
Jul. 18, 2017 (JP) 2017-139302

(51) Int. Cl. F16D 41/067

(52) U.S. Cl. CPC F16D 41/067; F16D 67/02

(57) ABSTRACT

A one-way clutch includes a rotating body, an outer ring arranged on an outer periphery of the rotating body, a roller, a biasing member, and a recess portion. The outer ring includes an indent portion. A wedge-shaped space is formed between the indent portion and an outer peripheral surface of the rotating body. The roller is disposed in the wedge-shaped space. The biasing member biases the roller to one side of the wedge-shaped space. The outer ring has a protrusion at a position corresponding to a radially outer side of the indent portion. The recess portion is formed continuously with the side surface in a circumferential direction of the protrusion on the outer peripheral surface of the outer ring.

### TECHNICAL FIELD

The present invention relates to a one-way clutch which allows rotation of a rotating body in one direction and restricts rotation in the other direction.

### BACKGROUND ART

One-way clutches which allow rotation of rotating bodies in one direction and restrict rotation in the other direction are used for various applications. The one-way clutch described in Patent Literature 1 has an inner ring and an outer ring arranged concentrically with the inner ring. A wedge-shaped space is formed between the inner ring and the outer ring. A roller is placed in the wedge-shaped space. The roller is held by a holder and is biased toward a narrow portion of the wedge-shaped space by a leaf spring. When the inner ring rotates in the other direction, the one-way clutch is locked. In the locked state, the roller is interposed between the outer ring and the inner ring in the narrow portion of the wedge-shaped space and the rotation of the inner ring relative to the outer ring is restricted. When the inner ring rotates in the one direction, the roller moves to a wide portion of the wedge-shaped space and the inner ring can rotate with respect to the outer ring.

In the outer ring of the one-way clutch described in Patent Literature 1, a cam surface constituting the wedge-shaped space is inclined with respect to a rotation direction of the inner ring. When the outer ring is formed by drawing a steel plate, a plurality of protrusions protruding corresponding to the inclination of the cam surface are formed on a part of an outer peripheral surface of the outer ring, which is the part corresponding to the radially outer side of the wedge-shaped space (see FIG. 3 of Patent Literature 1). This protrusion can be used as a detent when the one-way clutch is used in a state where the outer ring is attached to an attachment hole of an attachment target member. In other words, by providing a fitting groove in the attachment hole of the attachment target member and fitting the protrusion of the outer ring into the fitting groove, it is possible to prevent the outer ring from rotating inside the attachment hole by a torque received from the inner ring.

However, when the attachment target member is made of a material softer than the outer ring such as resin, for example, if an inclination of the protrusion of the outer ring is gentle, the inner surface of the fitting groove which abuts on the protrusion of the outer ring may be pushed outward, depending on a magnitude of the torque received from the inner ring. In this case, the outer ring may rotate in the attachment hole. Therefore, for example, an upper limit of the torque acting on the inner ring may be restricted to a small value.

For this reason, it is conceivable that the inclination of the side surface of the protrusion on the outer peripheral surface of the outer ring is made steeper than the inclination of the cam surface so that the protrusion of the outer ring can be easily engaged with the fitting groove. However, when forming the outer ring with such a shape by drawing, the inclination of the both end portions of the protrusion in a circumferential direction of the outer ring becomes gentle (see R portion 311e in FIG. 6 to be described below) and it is not possible to secure a sufficient engagement margin with the inner surface of the fitting groove.

### CITATION LIST

### Patent Literature

[Patent Literature 1]: JP-A-2005-90716

### SUMMARY OF INVENTION

According to an aspect of the invention, in an one-way clutch, while a side surface of a protrusion of an outer ring which functions as a detent for an attachment target member has an inclination steeper than that of a cam surface, an engagement margin of the protrusion of the outer ring which fits into a fitting groove of the attachment target member is secured, and thus the outer ring is reliably prevented from rotating.

### BRIEF DESCRIPTION OF DRAWINGS

FIG. 1 is a cross-sectional view illustrating a one-way clutch according to an embodiment.

FIG. 2 is a cross-sectional view taken along the line A-A of FIG. 1.

FIG. 3 is a perspective view illustrating a part of a holder and a biasing member of the one-way clutch.

FIG. 4(a) is a cross-sectional view illustrating one protrusion of a plurality of protrusions of an outer ring and a fitting groove of an attachment target member into which the protrusion is fitted, in a cross section perpendicular to a direction parallel to a rotation axis. FIG. 4(b) is a cross-sectional view illustrating the protrusion illustrated in FIG. 4(a). FIG. 4(c) is cross-sectional view illustrating the fitting groove illustrated in FIG. 4(a).

FIGS. 5(a) to 5(e) are explanatory views illustrating an example of a manufacturing process of the outer ring.

FIG. 6 is a partial cross-sectional view illustrating an outer ring according to a comparative example.

### DESCRIPTION OF EMBODIMENT

### Embodiment

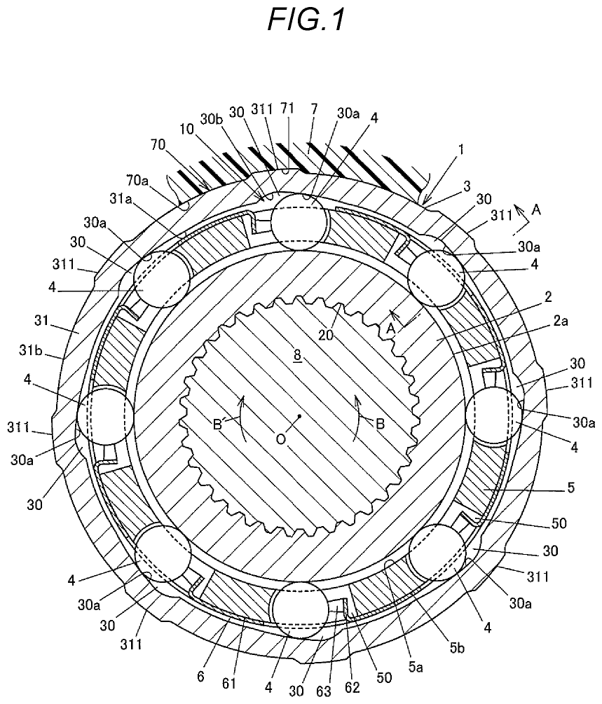

An embodiment will be described with reference to FIGS. 1 to 5(e). The embodiments described below are shown as specific example for carrying out the invention. Although there are portions that specifically illustrate various technical matters that are technically preferable, the technical scope of the invention is not limited to those specific embodiments.

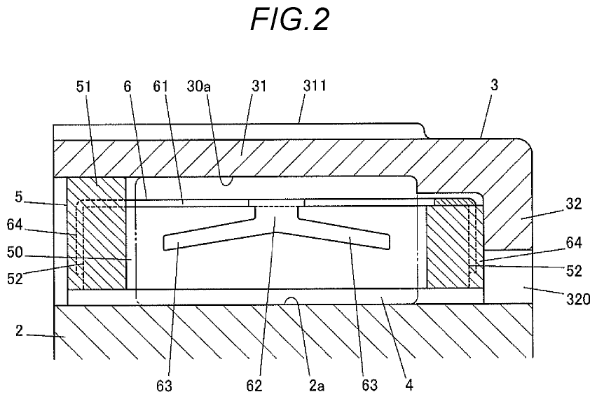

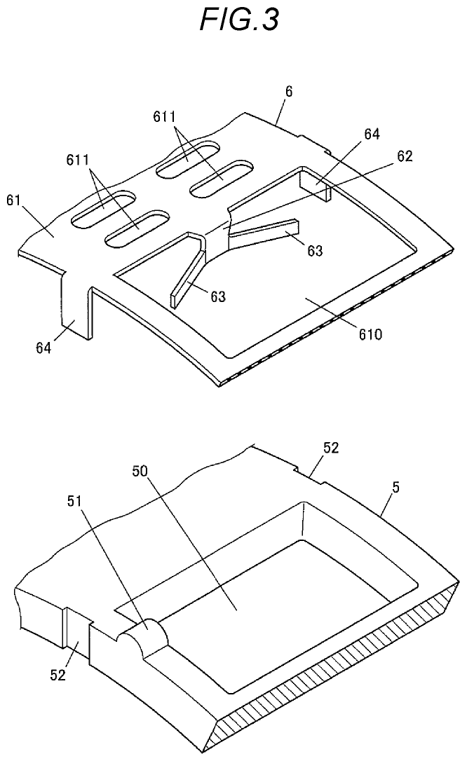

FIG. 1 is a cross-sectional view illustrating a one-way clutch according to the embodiment. FIG. 2 is a cross-sectional view taken along the line A-A of FIG. 1. FIG. 3 is a perspective view illustrating a part of a holder and a biasing member of the one-way clutch. The one-way clutch 1 is attached in an attachment hole 70 formed in an attachment target member 7. The one-way clutch 1 is used to allow a forward rotation of a shaft 8 with respect to the attachment target member 7 in a direction of the arrow B and to restrict a reverse rotation in a direction of the arrow B′ corresponding to the opposite side. The entirety of the one-way clutch 1 is accommodated in the attachment hole 70 of the attachment target member 7. However, only a part of the attachment target member 7 is illustrated in FIG. 1.

The one-way clutch 1 includes an inner ring 2 as a rotating body, an outer ring 3, a plurality of rollers 4, an annular holder 5, and a biasing member 6. The shaft 8 is connected to the inner ring 2 so as not to be relatively rotatable. The outer ring 3 is disposed around the outer periphery of the inner ring 2. The plurality of rollers 4 are disposed between the inner ring 2 and the outer ring 3. A plurality of holding holes 50 for holding the plurality of rollers 4 are formed in the annular holder 5. The biasing member 6 biases the roller 4 to one side of the holding hole 50 along a circumferential direction of the holder 5. In FIG. 2, the roller 4 is illustrated by a virtual line (two-dot chain line).

The inner ring 2, the outer ring 3, the roller 4, and the holder 5 are made of a steel material such as SCM415. The biasing member 6 is made of, for example, a SUP material (spring steel). The attachment target member 7 is made of a material softer than the outer ring 3. In the embodiment, the attachment target member 7 is made of resin.

The one-way clutch 1 may be used, for example, for a paper feeding mechanism of a copying machine, a printer, or the like. The inner ring 2 which rotates with the shaft 8 is allowed to rotate in one direction with respect to a housing as the attachment target member 7. The rotation of the inner ring 2 in the other direction (reverse direction) is restricted by the wedge effect of the roller 4. When the one-way clutch 1 is used in the paper feeding mechanism of the copying machine, the printer, or the like, a force which rotates the shaft 8 in the reverse direction may be applied when manually handling a paper jam.

A fitting hole 20 is provided at a center of the inner ring 2. The shaft 8 is fitted into the fitting hole 20. In the embodiment, the shaft 8 is connected to the inner ring 2 so as not to rotate relative to the inner ring 2 by spline fitting. However, the shaft 8 may be fixed to the inner ring 2 by, for example, a bolt. Further, the inner ring 2 and the shaft 8 may be integrated. In this case, the rotation of the rotating body in which the inner ring 2 and the shaft 8 are integrated in the reverse direction is restricted by the wedge effect of the roller 4.

The outer ring 3 includes a substantially cylinder-shaped cylindrical portion 31 and an inner flange portion 32 (see FIG. 2) which protrudes radially inward from one end portion of the cylindrical portion 31. Further, a cam surface 30a is provided on a part of an inner peripheral surface 31a of the cylindrical portion 31 of the outer ring 3. The cam surface 30a is inclined with respect to a rotation direction of the inner ring 2. A plurality of indent portions 30 are formed in the cylindrical portion 31 of the outer ring 3. A wedge-shaped space 10 is formed between the plurality of indent portions 30 of the outer ring 3 and an outer peripheral surface 2a of the inner ring 2. The cam surface 30a is the bottom surface of the indent portion 30. That is, a space between the cam surface 30a of the outer ring 3 and the outer peripheral surface 2a of the inner ring 2 forms the wedge-shaped space 10. The cylindrical roller 4 is disposed in the wedge-shaped space 10.

The radial width of the wedge-shaped space 10 in a radial direction of the inner ring 2 and the outer ring 3 is narrower than a diameter of the roller 4 at one end in the circumferential direction of the inner ring 2 and the outer ring 3 and wider than the diameter of the roller 4 at the other end in the circumferential direction. The roller 4 is held by the holder 5 so that the central axis direction thereof is parallel to a rotation axis O of the inner ring 2 and the shaft 8.

The dimension of the holder 5 in the radial direction of the inner ring 2 and the outer ring 3 is smaller than the diameter of the roller 4. Parts of the roller 4 protrude from an inner peripheral surface 5(a) and an outer peripheral surface 5(b) of the holder 5. In the embodiment, eight holding holes 50 are provided in the holder 5 at equal intervals along the circumferential direction. One roller 4 is accommodated in each holding hole 50. The holder 5 is provided with a plurality of convex portions 51 (see FIGS. 2 and 3) for fixing to the outer ring 3 at a plurality of locations. In FIG. 3, one of the convex portions 51 is illustrated. The convex portion 51 may be joined to the outer ring 3 by welding, for example.

As illustrated in FIG. 3, the biasing member 6 is integrally includes a belt-shaped annular body portion 61 disposed to face the outer peripheral surface 5(b) of the holder 5, an extending portion 62 extending from the annular body portion 61 into the holding hole 50, a pair of spring portions 63 protruding from the extending portion 62, and a plurality of engaging portions 64 engaged with engaged portions 52 formed in the holder 5. A plurality of square holes 610 are formed in the annular body portion 61 at positions corresponding to the plurality of holding holes 50 of the holder 5. The extending portion 62 protrudes into the square hole 610. A plurality of punched holes 611 for weight reduction may be formed in the annular body portion 61.

The biasing member 6 is fixed to the holder 5 by the engaging portion 64 engaging with the engaged portion 52. In the embodiment, the engaging portion 64 is formed as a protruding piece which protrudes radially inward from the end portion in the width direction (axial direction) of the annular portion 61 and the engaged portion 52 is formed as a notch formed in the axial end surface of the holder 5.

The pair of spring portions 63 protrude from the extending portion 62 in a direction inclined with respect to the axial direction of the holder 5. In the spring portions 63, a pair of tip end portions which abut on the outer peripheral surface of the roller 4 are free ends. The biasing member 6 biases the roller 4 to the one side of the wedge-shaped space 10 where the distance between the cam surface 30a and the outer peripheral surface 2a of the inner ring 2 is narrowed by the pair of spring portions 63 abutting the roller 4.

In the one-way clutch 1 configured as described above, when the shaft 8 rotates in the reverse direction (arrow B′ direction), the roller 4 rolls on the cam surface 30a of the outer ring 3 and the outer peripheral surface 2a of the inner ring 2 and is interposed between the outer ring 3 and the inner ring 2 to prevent further rotation of the shaft 8 in the reverse direction. On the other hand, when the shaft 8 rotates in the forward direction (arrow B direction), the rotation of the inner ring 2 moves the roller 4 to a portion where the wedge-shaped space 10 has a large radial width and the shaft 8 can freely rotate with respect to the attachment target member 7.

In the attachment target member 7, fitting grooves 71 respectively extending in a direction parallel to the rotation axis O are formed on an inner peripheral surface 70a of the attachment hole 70. The outer ring 3 has a plurality of protrusions 311 which fit into the fitting grooves 71 at positions corresponding to the radially outer side of the indent portion 30 in the cylindrical portion 31. The outer ring 3 is restricted from rotating relative to the attachment target member 7 by fitting the protrusions 311 into the fitting grooves 71. In the embodiment, as illustrated in FIG. 2, the protrusion 311 is provided in a partial region in the axial direction of the cylindrical portion 31. However, the protrusion 311 may be provided over the entire cylindrical portion 31 in the axial direction.

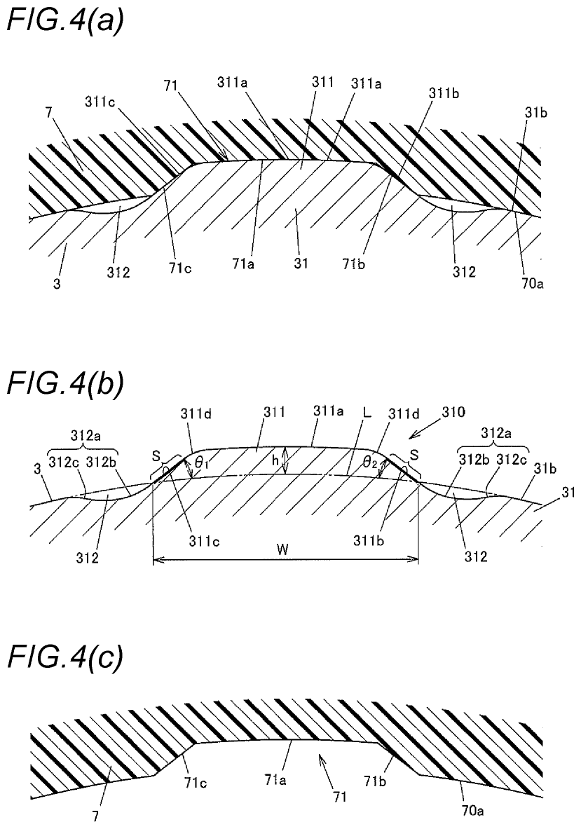

FIG. 4(a) is a cross-sectional view illustrating one protrusion 311 of the plurality of protrusions 311 of the outer ring 3 and the fitting groove 71 of the attachment target member 7 into which the protrusion 311 is fitted, in a cross section perpendicular to the direction parallel to the rotation axis O. FIG. 4(b) is a cross-sectional view illustrating the protrusion 311 illustrated in FIG. 4(a). FIG. 4(c) is a cross-sectional view illustrating the fitting groove 71 illustrated in FIG. 4(a).

The protrusion 311 has a width W in the circumferential direction of the cylindrical portion 31 of, for example, 1.9 mm and extends parallel to the rotation axis O. Further, the protrusion 311 has a tip end surface 311a having a circular arc section with the rotation axis O as the center of the arc and first and second side surfaces 311b and 311c inclined with respect to the rotation direction of the inner ring 2. The first and second side surfaces 311b and 311c are both side surfaces of the protrusion 311 in the circumferential direction. In FIG. 4(b), the first and second side surfaces 311b and 311c are indicated by bold lines. The tip end surface 311a is formed in a range including a portion corresponding to the outer side of a deepest portion 30b (see FIG. 1) of the indent portion 30 in the radial direction of the cylindrical portion 31. The first side surface 311b is formed at a portion corresponding to the outside of the cam surface 30a. The second side surface 311c is formed in a portion corresponding to the outside of the inner peripheral surface 31a of the cylindrical portion 31 where the indent portion 30 is not formed.

Between the tip end surface 311a and the first side surface 311b and between the tip end surface 311a and the second side surface 311c, R-portions (rounded portions) 311d each having a predetermined radius of curvature are formed respectively. The radius of curvature of the R-portion 311d is, for example, 0.3 mm. In the cross section illustrated in FIGS. 4(a) and 4(b), the first and second side surfaces 311b and 311c have straight like shapes continuous to the respective R-portions 311d. The dimension between the first side surface 311b and the second side surface 311c in the circumferential direction of the cylindrical portion 31 gradually increases as it moves away from the tip end surface 311a.

On an outer peripheral surface 31b of the cylindrical portion 31 of the outer ring 3 between the plurality of protrusions 311, a pair of recess portions 312 which are respectively formed continuously to the first and second side surfaces 311b and 311c are provided. In other words, the protrusion 311 is provided between the pair of recess portions 312. Hereinafter, a partial region in the circumferential direction of the cylindrical portion 31, the region including the pair of recess portions 312 and one protrusion 311 provided therebetween, is referred to as a protruding region 310. In the embodiment, eight protruding regions 310 are formed at equal intervals on the cylindrical portion 31. The first and second side surfaces 311b and 311c are straight portions S in which the cross-sectional shape of the protruding region 310 is a straight like line in the cross section shown in FIG. 4(b). An imaginary line L illustrated in FIG. 4(b) is an extension line obtained by extending the outer peripheral surface 31b of the cylindrical portion 31 between two protruding regions 310 adjacent in the circumferential direction in the circumferential direction with respect to the rotation axis O.

A height h of the protrusion 311 with respect to the imaginary line L is, for example, one tenth of the circumferential width W of the protrusion 311. Moreover, in the example of illustration of FIG. 4(a) and FIG. 4(b), the angles θ1 and θ2 formed by the first and second side surfaces 311b and 311c and the circumferential direction of the cylindrical portion 31 along the virtual line L are 30°. A preferable range of the angles θ1 and θ2 is 30° or more and 45° or less. When the angles θ1 and θ2 are less than 30°, the effect of preventing the outer ring 3 from rotating with respect to the attachment target member 7 cannot be sufficiently obtained. When the angles θ1 and θ2 exceed 45°, it is difficult to accurately form the protrusion 311 by drawing processing described below.

The inclination angle of the cam surface 30a with respect to the circumferential direction of the cylindrical portion 31 is, for example, 10°. Accordingly, the angles θ1 and θ2 which are the inclination angles of the first and second side surfaces 311b and 311c with respect to the circumferential direction of the cylindrical portion 31 are larger than the inclination angle of the cam surface 30a.

The recess portion 312 is recessed from the imaginary line L inward in the radial direction of the cylindrical portion 31. The inner surface 312a of the recess portion 312 is a curved surface having a radius of curvature of 0.3 mm or more in the cross section illustrated in FIGS. 4(b) and 4(c). In the embodiment, the inner surfaces 312a of the recess portions 312 in the cross section illustrated in FIG. 4(b) are constituted of first curved surfaces 312b continuous with the first and second side surfaces 311b and 311c and second curved surfaces 312c which smoothly connect the outer peripheral surface 31b of the cylindrical portion 31 with respect to the protruding regions 310 adjacent in the circumferential direction and the first curved surfaces 312b. The first curved surface 312b is a curved surface which indents inward with respect to the radial direction of the cylindrical portion 31 and the second curved surface 312c is a curved surface which protrudes outward with respect to the radial direction of the cylindrical portion 31.

A preferable range of the radius of curvature of the inner surface 312a (first and second curved surfaces 312b and 312c) of the recess portion 312 is 0.3 mm or more and 1.0 mm or less. In the embodiment, the curvature radii of the first curved surface 312b and the second curved surface 312c are both 0.5 mm. When the curvature radii of the first curved surface 312b and the second curved surface 312c are less than 0.3 mm, it is difficult to accurately form the recess portion 312 by drawing processing described below. When the curvature radii of the first curved surface 312b and the second curved surface 312c exceed 1.0 mm, the recess portion 312 becomes larger than necessary. The radius of curvature of the first curved surface 312b and the radius of curvature of the second curved surface 312c may be the same or different. In this way, the protruding region 310 in the cross section perpendicular to the rotation axis O is constituted of a curve having a curvature radius of 0.3 mm or more, except for the first and second side surfaces 311b and 311c formed in a straight line and those curves are formed smoothly and continuously.

As illustrated in FIG. 4(c), the inner surface of the fitting groove 71 of the attachment target member 7 includes a bottom surface 71a and a pair of abutment surfaces 71b and 71c. The bottom surface 71a faces the tip end surface 311a of the protrusion 311 of the outer ring 3. The abutment surface 71b abuts on the first side surface 311b of the protrusion 311 and the abutment surface 71c abuts on the second side surface 311c of the protrusion 311.

Manufacturing Method of Outer Ring 3

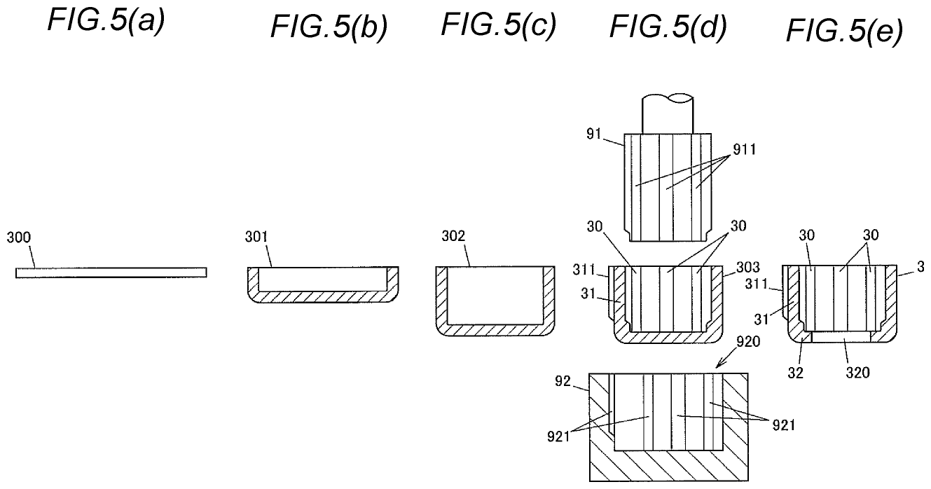

A method for manufacturing the outer ring 3 will be described with reference to FIG. 5.

FIGS. 5(a) to 5(e) are explanatory views illustrating an example of the manufacturing process of the outer ring 3. The outer ring 3 is formed by a transfer press in which a plurality of press processes are sequentially performed at a multistage processing station. FIG. 5(a) illustrates a disk-shaped thin steel plate 300 which is a material of the outer ring 3 and FIGS. 5(b) and 5(c) respectively illustrate first and second pressed bodies 301 and 302 in the middle of processing, which are pressed into a cup shape. The second pressed body 302 is drawn by an upper die (punch) 91 and a lower die (die) 92 as illustrated in FIG. 5(d), in such a manner that the second pressed body 302 becomes a third pressed body 303. Further, the outer ring 3 is obtained by forming a through-hole 320 in the center part of the bottom portion of the third pressed body 303 as illustrated in FIG. 5(e).

In the drawing process using the upper die 91 and the lower die 92, after the upper die 91 is inserted inside the cup-shaped second pressed body 302, the upper die 91 is pressed down into a die hole 920 of the lower die 92 together with the second pressed body 302. A plurality of convex portions 911 having a shape corresponding to the indent portion 30 are provided on the outer peripheral surface of the upper die 91. On the inner peripheral surface of the die hole 920 of the lower die 92, a protruding region forming portion 921 having an uneven shape corresponding to the protrusion 311 and the recess portion 312 of the protruding region 310 is provided. The outer diameter of the second pressed body 302 is reduced by the drawing process and the indent portion 30 and the protruding region 310 are formed.

### Comparative Example

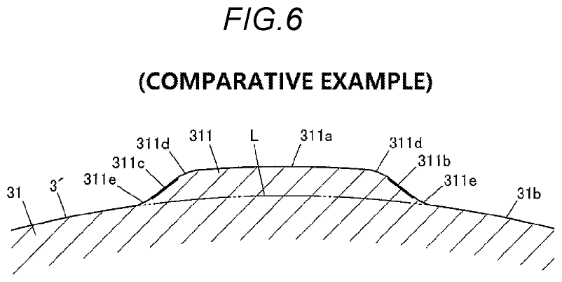

FIG. 6 is a partial cross-sectional view illustrating an outer ring 3′ according to a comparative example. As similar to the outer ring 3 according to the embodiment described above, the outer ring 3′ has a protrusion 311 in a portion corresponding to the outside of the indent portion 30, but the recess portion 312 is not formed. That is, the outer ring 3′ is drawn by a lower die which does not have a convex portion corresponding to the recess portion 312.

In the outer ring 3′, the lengths of the linear portions (straight portions indicated by bold lines) of the first and second side surfaces 311b and 311c in the protrusion 311 are shortened and both end portions in the circumferential direction of the protrusion 311 are, for example, R-portions 311e having curvature radii of 0.3 mm. Therefore, the length of the effective engagement margin for preventing the outer ring 3′ from rotating becomes short. As a result, when a large force for rotating the inner ring 2 in the reverse direction is applied to the shaft 8, there is a concern that the outer ring 3′ may be rotated with respect to the attachment target member 7.

In the outer ring 3 according to the embodiment, since the R-portion 311e is not formed, it is possible to ensure a large effective engagement margin due to the first and second side surfaces 311b and 311c. Therefore, the rotation of the outer ring 3 relative to the attachment target member 7 can be more reliably prevented than those of the outer ring 3′ according to the comparative example.

### Effect of Embodiment

According to the one-way clutch 1 according to the embodiment described above, it is possible to securely prevent the outer ring 3 from rotating by securing the engagement margin of the protrusion 311 of the outer ring 3 with respect to the fitting groove 71 of the attachment target member 7, while the inclination of the first and second side surfaces 311b and 311c of the protrusion 311 of the outer ring functioning as a detent against the attachment target member 7 is set to be larger than the inclination of the cam surface 30a. Further, the inner surface 312a of the recess portion 312 is a curved surface having a radius of curvature of 0.3 mm or more in a cross section perpendicular to the rotation axis O of the inner ring 2. Therefore, the pair of recess portions 312 and the protrusion 311 in the protruding region 310 can be processed with high accuracy by following the shape of the protruding region forming portion 921 of the die hole 920 of the lower die 92.

### APPENDIX

Hereinbefore, although one viewpoint of the invention is demonstrated based on the embodiment, the embodiment does not limit the invention described in claims. In addition, all the combinations of features described in the embodiment are not necessarily essential to the means for solving the problems of the invention.

Further, the invention can be appropriately modified and implemented without departing from the spirit of the present invention. For example, in the embodiment described above, as an application of the one-way clutch 1, a case where the rotation of the shaft 8 of the paper feeding mechanism of a copying machine or a printer is regulated in one side is exemplified. However, the application of the one-way clutch 1 is not limited to this and the one-way clutch 1 may be used for a fishing reel, for example. Further, the number of rollers 4 and indent portions 30 is not limited to the above and can be changed as appropriate. Furthermore, in the embodiment described above, a case where the pair of spring portions 63 of the biasing member 6 is constituted of a leaf spring is described. However, the spring portion 63 is not limited to this and the roller 4 may be biased by a coil spring, for example.

According to the embodiment, the one-way clutch 1 is attached in the attachment hole 70 formed in the attachment target member 7. In the one-way clutch 1, rotation in one direction of the rotating body 2 rotating with respect to the attachment target member 7 is allowed and rotation in the other direction of the rotating body 2 is restricted. The one-way clutch 1 includes the rotating body 2, the outer ring 3 disposed on the outer periphery of the rotating body, the roller 4, the biasing member 6, and the recess portion 312. The outer ring 3 includes the indent portion 30 which forms a wedge-shaped space 10 between the cam surface 30a formed to be inclined with respect to the rotation direction of the rotating body 2 and the outer peripheral surface 2a of the rotating body 2. The roller 4 is disposed in the wedge-shaped space 10. The biasing member 6 biases the roller 4 to one side of the wedge-shaped space 10 where the distance between the cam surface 30a and the outer peripheral surface 2a of the rotating body 2 is narrowed. The outer ring 3 has the protrusion 311 which fits into the fitting groove 71 formed in the inner peripheral surface 70a of the attachment hole 70 at a position corresponding to the radially outer side of the indent portion 30. In the outer peripheral surface 31b of the outer ring 3, the recess portion 312 is formed continuously to the side surfaces 311b and 311a in the circumferential direction of the protrusion 311.

According to the one-way clutch of the embodiment, it is possible to reliably prevent the outer ring from rotating by securing the engagement margin for the protrusion of the outer ring which fits into the fitting groove of the attachment target member, while the inclination of the side surface of the protrusion of the outer ring which functions as a detent against the attachment target member is set to be larger than the inclination of the cam surface.

This application is based on a Japanese patent application filed on Jul. 18, 2017 (Japanese Patent Application No. 2017-139302), the contents of which are incorporated herein by reference.

### REFERENCE SIGNS LIST

1: one-way clutch
10: wedge-shaped space
2: inner ring (rotating body)
3: outer ring
30: indent portion
30a: cam surface
311: protrusion
312: recess portion
4: roller
5: holder
50: holding hole
6: biasing member
7: attachment target member
70: attachment hole
71: fitting groove

1. A one-way clutch to be attached into an attachment hole formed in an attachment target member, in which a rotating body is rotatable in one direction relative to the attachment target member and the rotating body is restricted to rotate in the other direction, the one-way clutch comprising:
the rotating body;
an outer ring disposed on an outer periphery of the rotating body;
a roller;
a biasing member; and
a recess portion,
wherein the outer ring includes an indent portion that forms a wedge-shaped space between a cam surface inclined with respect to a rotation direction of the rotating body and an outer peripheral surface of the rotating body,
wherein the roller is disposed in the wedge-shaped space,
wherein the biasing member biases the roller to one side of the wedge-shaped space where a distance between the cam surface and the outer peripheral surface of the rotating body is narrow,
wherein the outer ring has a protrusion to fit into a fitting groove formed on an inner peripheral surface of the attachment hole at a position corresponding to a radially outer side of the indented portion, and
wherein the recess portion is formed on an outer peripheral surface of the outer ring so as to be continuous to a circumferential side surface of the protrusion.

2. The one-way clutch according to claim 1, wherein an inner surface of the recess portion has a curved surface with a curvature radius of 0.3 mm or more in a cross section perpendicular to a rotation axis of the rotating body.
